(19) United States
(12) Patent Application Publication
(10) Pub. No.: US 2023/0121778 A1
(43) Pub. Date: Apr. 20, 2023

(54) Apparatuses, Devices, Methods, Computer Systems and Computer Programs for Handling Remote Procedure Calls

(71) Applicant: Intel Corporation, Santa Clara, CA (US)

(72) Inventors: Joseph GRECCO, Saddle Brook, NJ (US); Mukesh Gangadhar BHAVANI VENKATESAN, Bangalore (IN); Hariharan M, Palakkad (IN)

(21) Appl. No.: 18/067,050

(22) Filed: Dec. 16, 2022

(51) Int. Cl. G06F 21/62

(52) U.S. Cl. CPC G06F 21/6218

(57) ABSTRACT

Various examples relate to apparatuses, devices, methods, computer systems and computer programs for handling remote procedure calls. A non-transitory, computer-readable medium comprises machine-readable instructions that, when the program code is executed on a processor of a requesting host, causes the processor to provide an interface for locally receiving remote procedure calls from a plurality of threads of a computer program, and forward, upon receiving a remote procedure call from one of the threads of the computer program, the remote procedure call to a providing host that provides the functionality associated with the remote procedure call, wherein the remote procedure call is forwarded together with information on the thread having issued the remote procedure call.

### BACKGROUND

Remote Procedure Calls (RPC) are a long-established technology. RPCs are generally used to enable an application to invoke a function from one computer while performing the execution of the function on a remote computer. When used to move existing APIs (Application Programming Interfaces) to a remote host, RPC implementations usually aim to reflect the same procedure call behavior as if the application is run locally.

There are different techniques for improving or optimizing the performance of an API. One such technique is to parallelize (i.e., temporally overlap) function calls using threads, where allowed by the API. When accessing the RPC via a remote procedure call, this desired concurrency may not be properly reflected. In many cases, RPC schedulers tend to blindly marshal/de-marshal and send the request/responses, without regard to concurrency. Function calls are often serialized during transmission to the remote end using a single channel (i.e., session) to reduce overhead. Concurrency information is often lost in the transmission.

On the side of the host executing the function calls, the RPC framework generally cannot deduce the concurrency properties of the calls it receives. As a result, an application designed with an intimate understanding of the API, and with a usage of threads for overlapping function calls, may not have those desired characteristics accurately reflected remotely. Functions that, when accessing the APU locally, would have executed in parallel may now be artificially serialized by the RPC. Such behavior may not be immediately evident, as the application may usually continue to function, but may not perform as well as it could.

To enforce concurrency, special APIs may be used to perform the parallelism the applications desire. However, the user of special APIs adds complexity to the applications for developers and potential overheads that may diminish the value of using parallelism.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for a requesting host, and of a computer system comprising such an apparatus or device;

FIG. 1b shows a flow chart of an example of a method for a requesting host;

FIG. 2a shows a schematic diagram of an example of an apparatus or device for a providing host, and of a computer system comprising such an apparatus or device;

FIG. 2b shows a flow chart of an example of a method for a providing host;

FIG. 3 shows a schematic diagram of an example of the different actors; and

FIG. 4 shows an illustrative example of a flow of a proposed algorithm.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

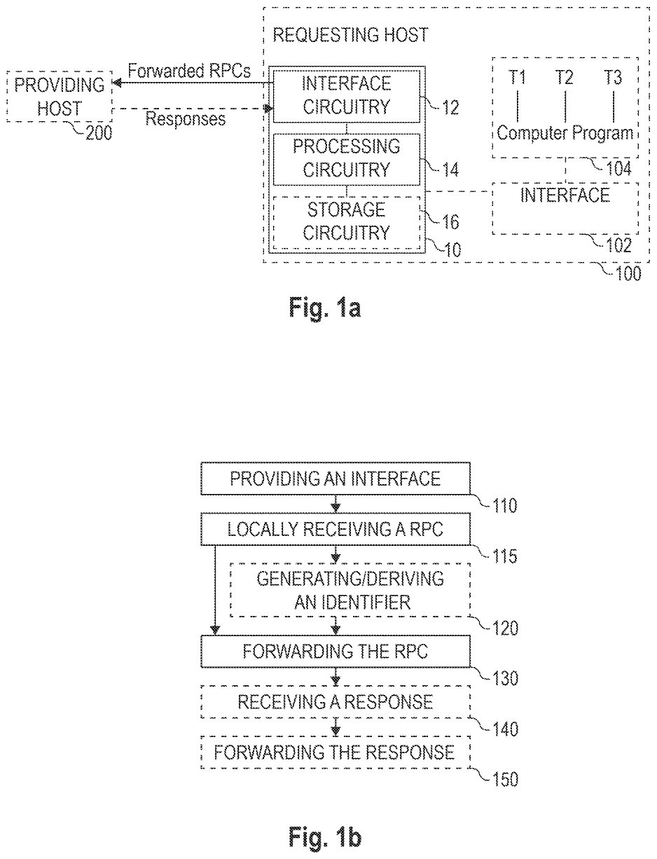

FIG. 1a shows a schematic diagram of an example of an apparatus 10 or device 10 for a requesting host 100, and of a computer system 100 (i.e., the requesting host) comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10, such as a providing host 200) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to provide an interface 102 for locally receiving remote procedure calls from a plurality of threads T1, T2, T3 of a computer program 104 (or more generally, an application, which may comprise software and/or hardware logic). The processing circuitry 14 or means for processing 14 is to forward, upon receiving a remote procedure call from one of the threads of the computer program, the remote procedure call to the providing host 200 that provides the functionality associated with the remote procedure call. The remote procedure call is forwarded together with information on the thread having issued the remote procedure call.

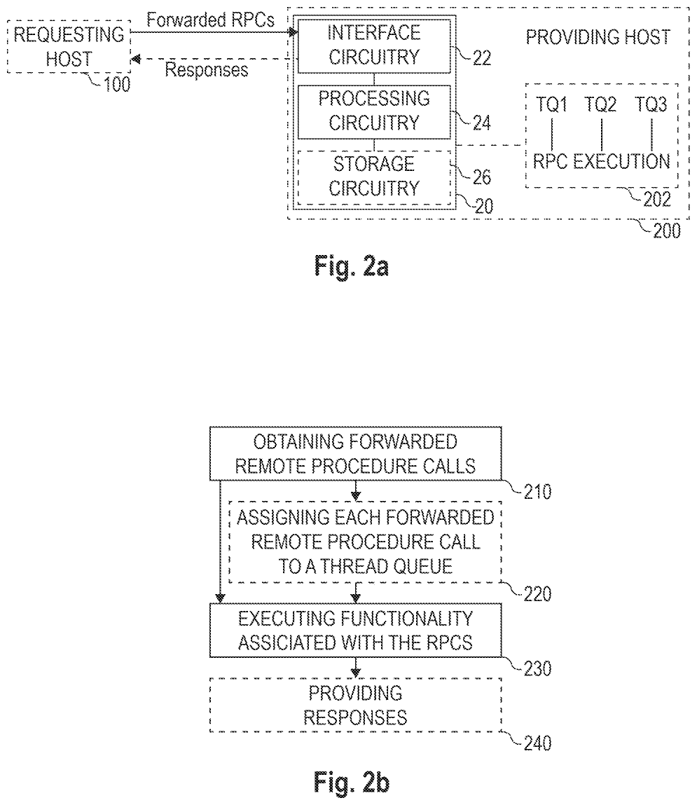

FIG. 1a further shows a system comprising the requesting host 100 (with the apparatus 10 or device 10) and the providing host 200 (with an apparatus 20 or device 20 introduced in connection with FIG. 2a).

FIG. 1b shows a flow chart of an example of a corresponding method for the requesting host 200. The method comprises providing 110 the interface 102 for locally receiving remote procedure calls from the plurality of threads T1, T2, T3 of the computer program 104. The method comprises forwarding 130, upon receiving 115 a remote procedure call from one of the threads of the computer program, the remote procedure call to the providing host 200 that provides the functionality associated with the remote procedure call. The remote procedure call is forwarded together with information on the thread having issued the remote procedure call. For example, the method may be performed by a computer system 100, i.e., the requesting host 100.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

Various examples of the present disclosure relate to remote procedure calls (RPCs). Computer programs, such as the application 104, can make use of external resources, such as another computer program, another hardware device, a web service etc., by accessing these external resources via an interface provided by the respective resource. For example, locally, such an interface can be an Application Programming Interface (API) that is provided by a computer program, by a program library, or by a driver of a hardware device. The application can use the resource by “calling” (i.e., invoking) the API. The resource can then provide some functionality in response to the API being called. Inside the same computer system, such an API can be called via local inter-process communication, which is a technology that enables communication between different processes running on the same computer system. In some cases, the same paradigm, i.e., inter-process communication, may be expanded beyond a single computer system (or be expanded beyond applications hosted in the user space of the same operating system). In this case, a process being run on a first computer system communicates with another processing being run on a second computer system. In this case, a so-called remote procedure call may be used to implement the inter-process communication. For example, an API may be called, from a local computer, via a remote procedure call, at a remote computer, with the same parameters that are being used for calling the API on the local computer. The same can be done between different operating systems being executed concurrently on the same computer systems, e.g., as host and virtual machine or container, or as different virtual machines or containers being executed on the same computer system. In some examples, e.g., if a central interface is used to route inter process communication between different processes, the concept proposed herein may also be applied to inter process communication being performed locally on the same computer system.

In general, to call a remote procedure, a message is sent from a requestor (i.e., the requesting host 100) to a provider (i.e., the providing host 200), with the message comprising the procedure being called and, if used, parameters of the procedure being called. In an alternative wording, the requestor may also be called a “client”, and the provider may be called a “server”. A server process of the provider handles the procedure call, and, if applicable, replies with a response. In many implementations, the call is blocking, i.e., the application, and in particular the thread of the application calling the remote procedure needs to wait until the result of the response has arrived from the providing host. Alternatively, the remote procedure may be called asynchronously, i.e., in a non-blocking manner.

In the present scenario, remote procedures are called by different threads T1, T2, T3 of a computer program. If the remote procedure calls are transmitted independently by the different threads to the providing host, they are usually brought into an implicit order by the session management of the respective RPC implementation. Thus, the remote procedure calls are generally processed according to the order, in which they are transmitted to the providing host, one after another, without overlap. In some cases, this behavior may be undesirable. In particular, this becomes relevant if a computer program employs concurrency/parallelism, i.e., if the computer program spawns multiple threads to perform different tasks (or the same task with different sets of data) at the same time. In this case, as the providing host is unaware of the use of concurrent threads on the side of the providing host, it will simply process one remote procedure call after another, without allowing for concurrent execution of the remote procedure calls. This implicit serialization of the processing of the remote procedure calls by the providing host may become a bottleneck to the performance benefits obtainable from the use of concurrency.

In the proposed concept, the remote procedure calls are enriched with concurrency information, and in particular with information about the thread having issued the remote procedure call. This way, the providing host 200 is made aware that different remote procedure calls are provided by different threads T1, T2, T3 of the computer program 104. With that knowledge, the providing host can safely execute the different remote procedure calls concurrently, which may enable reaping the performance gains made possible by the parallel processing of the different tasks. This may improve the performance of the computer program.

In the proposed concept, the remote procedure calls are enriched by the interface 102. The interface 102 is a software interface, which collects the remote procedure calls and forwards them to the providing host. For example, the apparatus 10, and in particular the interface 102 provided by the apparatus 10, may implement a function dispatcher for forwarding the remote procedure calls to the providing host.

In addition, when a response is received, the response is routed via the interface from the providing host to the thread having issued the corresponding remote procedure calls. In other words, the processing circuitry may forward, upon receiving a response from the providing host in response to a remote procedure call, the response to the respective thread having issued the remote procedure call having triggered the response. Accordingly, as further shown in FIG. 1b, the method may comprise forwarding 150, upon receiving 140 the response from the providing host in response to a remote procedure call, the response to the respective thread having issued the remote procedure call having triggered the response.

While the apparatus 10 or interface 102 implements the function dispatcher on the side of the requesting host 100, its counterpart on the side of the providing host 200 is a service scheduler. For example, the forwarded remote procedure calls may be forwarded to the service scheduler of the providing host. Additionally, or alternatively, responses received from the providing host may be received from the service scheduler of the providing host. For example, the service scheduler may be implemented by an apparatus 20 or device 20 of the providing host 200, which will be introduced in connection with FIGS. 2a and 2b.

The interface 102 (locally) receives the remote procedure calls from the respective threads of the computer program, enriches them with concurrency information, and then forwards them to the providing host 200 that (actually) provides the functionality associated with the remote procedure call. To enrich the remote procedure calls with the concurrency information, the concurrency information, and in particular the information on the thread having issued the remote procedure call, may be determined by the interface, and ultimately the processing circuitry.

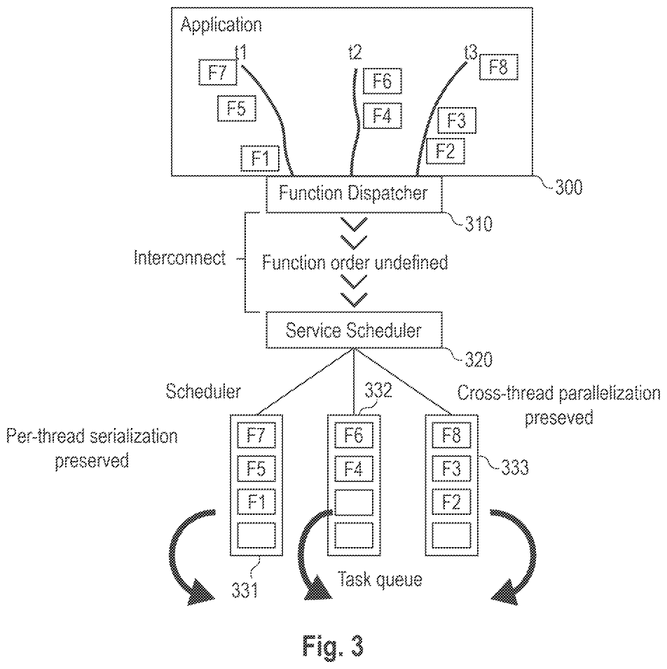

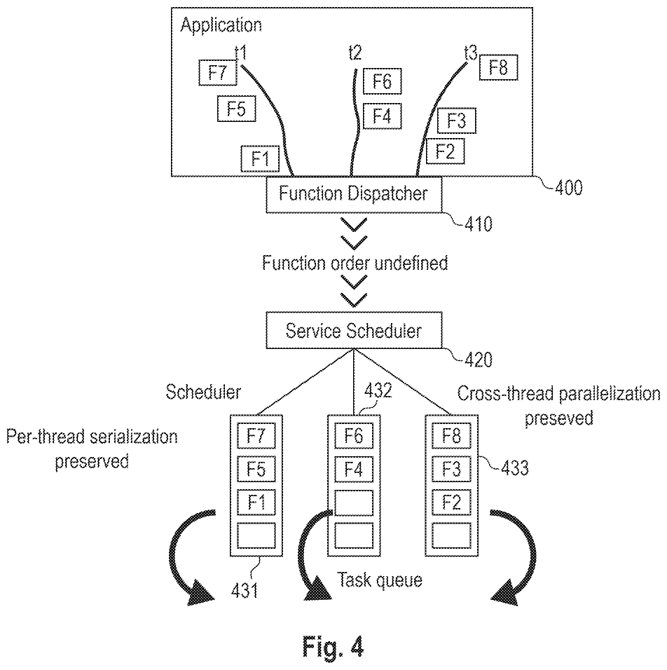

For example, the remote procedure call may be forwarded with a concurrency identifier, named concurrencyID (concurrency identifier) in connection with the examples presented in connection with FIGS. 3 and 4, which may represent (at least) the thread having issued the remote procedure call. For example, the processing circuitry may generate an identifier (e.g., the concurrency identifier) for identifying the thread having issued the remote procedure call, and to forward the remote procedure call together with the identifier for identifying the thread. Accordingly, as further shown in FIG. 1b, the method may comprise generating 120 the identifier for identifying the thread having issued the remote procedure call and forwarding 130 the remote procedure call together with the identifier for identifying the thread.

This concurrency identifier can be based on one or more pieces of information. To achieve concurrency, the providing host may need to distinguish remote procedure calls being issued by different threads being executed on the requesting host. In a straightforward way, this can be done by using a thread identifier of the respective threads, e.g., the pthreads identifier under Linux or macOS® (a trademark of Apple Inc.), or a thread handle under Microsoft Windows (Microsoft and Windows are trademarks of the Microsoft group of companies). For example, the processing circuitry may derive the identifier from an operating-system generated thread identifier (e.g., pthread identifier or thread handle) of the thread. Accordingly, the method may comprise deriving 120 the identifier from an operating-system generated thread identifier of the thread.

In addition to the thread identifier, it may be useful for the providing host to know that different threads belong to the same computer program. This may be done via the process identifier used by the computer program. For example, the processing circuitry may derive the identifier from an operating-system generated process identifier of the computer program. Accordingly, the method may comprise deriving 120 the identifier from an operating-system generated process identifier of the computer program. Additionally, or alternatively, this property may be derived from a communication session (e.g., a Transmission Control Protocol, TCP, session) that is being used for (all of) the RPC communication of the computer program. For example, the processing circuitry may derive the identifier from an identifier of a (computer program-specific) communication session (e.g., TCP session) being established between an operating system being used to execute the computer program and the providing host. Accordingly, the method may comprise deriving 120 the identifier from an identifier of a communication session being established between an operating system being used to execute the computer program and the providing host.

In addition to distinguishing different threads running on the same computer system, further information may be included for distinguishing different nodes, e.g., different computer systems. For example, the processing circuitry may derive the identifier from an identifier of a node, e.g., of the computer system 100, executing the computer program.

Finally, additional information about the threads may be included. For example, in modern operating systems, processes and threads can be executed at different levels of priority, between highest priority and idle. For example, the processing circuitry may forward the remote procedure call with information on a thread priority of the thread having issued the remote procedure call. This may enable the providing host to apply the same thread priority on the execution of the respective remote procedure call.

As outlined above, the information on the thread having issued the remote procedure call may primarily be used to determine that different remote procedure calls originate from different threads on the requesting host, so the remote procedure calls can be executed with some measure of concurrency. Thus, the information on the thread having issued the remote procedure call, such as the thread identifier, process identifier, node identifier, communication session identifier etc. may be suitable for distinguishing the different threads, i.e., for determining that different remote procedure calls being issued by different threads have been issued by different threads. In other words, the processing circuitry may forward, upon receiving remote procedure calls from different threads, the remote procedure calls with information for distinguishing the threads having issued the remote procedure calls. Accordingly, the method may comprise forwarding 130, upon receiving remote procedure calls from different threads, the remote procedure calls with information for distinguishing the threads having issued the remote procedure calls.

To achieve this, a different identifier may be generated for each of the threads. For example, the processing circuitry may generate, for each of the threads having issued a remote procedure call, an identifier for identifying the thread having issued the respective remote procedure call, and to forward the remote procedure call together with the respective identifiers for identifying the thread. Accordingly, the method may comprise generating 120, for each of the threads having issued a remote procedure call, an identifier for identifying the thread having issued the respective remote procedure call and forwarding 130 the remote procedure call together with the respective identifiers for identifying the thread. For example, the respective identifier may be persistent across remote procedure calls by the same thread, and different between remote procedure calls of different threads.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a server computer system, i.e., a computer system being used to serve functionality, such as functionality provided by the virtual machine, to one or more client computers.

The present computer system may further comprise memory. For example, the memory may be random access memory, such as dynamic random-access memory (DRAM), e.g., DRAM being part of a Dual Inline Memory Module (DIMM) or DRAM being part of High Bandwidth Memory. Alternatively, the memory may be persistent memory, e.g., persistent memory being part of a DIMM.

More details and aspects of the requesting host 100, the apparatus 10, the device 10, the method, the computer program, and the providing host 200 are mentioned in connection with the proposed concept or one or more examples described above or below (e.g., FIGS. 2a to 4).

The requesting host 100, the apparatus 10, the device 10, the method, the computer program, and the providing host 200 may comprise one or more additional optional features corresponding to one or more aspects of the proposed concept, or one or more examples described above or below.

FIG. 2a shows a schematic diagram of an example of an apparatus 20 or device 20 for a providing host 200, and of a computer system 200 (i.e., the providing host) comprising such an apparatus 20 or device 20. The apparatus 20 comprises circuitry to provide the functionality of the apparatus 20. For example, the circuitry of the apparatus 20 may be configured to provide the functionality of the apparatus 20. For example, the apparatus 20 of FIGS. 2a and 2b comprises interface circuitry 22, processing circuitry 24 and (optional) storage circuitry 26. For example, the processing circuitry 24 may be coupled with the interface circuitry 22 and with the storage circuitry 26. For example, the processing circuitry 24 may provide the functionality of the apparatus, in conjunction with the interface circuitry 22 (for exchanging information, e.g., with other components inside or outside the computer system 200 comprising the apparatus or device 20, such as a requesting host 100 as introduced in connection with FIG. 1a) and the storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIGS. 2a and 2b comprises means for processing 24, which may correspond to or be implemented by the processing circuitry 24, means for communicating 22, which may correspond to or be implemented by the interface circuitry 22, and (optional) means for storing information 26, which may correspond to or be implemented by the storage circuitry 26. In general, the functionality of the processing circuitry 24 or means for processing 24 may be implemented by the processing circuitry 24 or means for processing 24 executing machine-readable instructions. Accordingly, any feature ascribed to the processing circuitry 24 or means for processing 24 may be defined by one or more instructions of a plurality of machine-readable instructions. The apparatus 20 or device 20 may comprise the machine-readable instructions, e.g., within the storage circuitry 26 or means for storing information 26.

The processing circuitry 24 or means for processing 24 is to obtain, from a requesting host 100 requesting access to functionality being provided by the providing host, forwarded remote procedure calls. The remote procedure calls are forwarded together with information on a thread having issued the respective remote procedure call. The processing circuitry 24 or means for processing 24 is to execute functionality associated with the forwarded remote procedure calls based on the information on the thread having issued the respective remote procedure call.

FIG. 2a further shows a system comprising the providing host 200 (with the apparatus 20 or device 20) and the requesting host (with the apparatus 10 or device 10 shown in connection with FIG. 1a).

FIG. 2b shows a flow chart of an example of a corresponding method for the providing host 200. The method comprises obtaining 210, from the requesting host 100 requesting access to functionality being provided by the providing host, forwarded remote procedure calls. The remote procedure calls are forwarded together with information on a thread having issued the respective remote procedure call. The method comprises executing 230 functionality associated with the forwarded remote procedure calls based on the information on the thread having issued the respective remote procedure call. For example, the method may be performed by the computer system 200 (i.e., the providing host).

In the following, the functionality of the apparatus 20, the device 20, the method and of a corresponding computer program is illustrated with respect to the apparatus 20. Features introduced in connection with the apparatus 20 may likewise be included in the corresponding device 10, method and computer program.

In connection with FIGS. 1a and 1b, the requesting side was discussed, i.e., the side executing the computer program making the remote procedure calls. FIGS. 2a and 2b now relate to their counterpart, i.e., the providing host that is being called by the remote procedure calls.

As outlined in connection with FIGS. 1a and 1b, the threads of the computer program issue the remote procedure calls, which are then received and forwarded by the interface 102 provided by apparatus 10 of FIG. 1a. Together with the forwarded remote procedure calls, the information on the thread having issued the respective remote procedure call (e.g., the concurrency identifier) is provided, e.g., as metadata attached to the respective remote procedure call. For example, the processing circuitry may include the information on the thread having issued the respective remote procedure call (e.g., the concurrency identifier) as part of a header of a network packet being used to forward the remote procedure call, or encapsulate both the remote procedure call and the metadata in a common network packet. The information on the thread may comprise various pieces of information, such as the thread identifier, process identifier, node identifier, communication session identifier, thread priority etc. The apparatus 20 now uses this information to execute the functionality associated with the forwarded remote procedure calls, i.e., to process (and optionally respond) to the remote procedure calls.

The providing host 200 serves the functionality being accessed via the remote procedure calls. For example, the providing host 200 may execute server processes for handling the remote procedure calls, i.e., for providing the functionality being requested by the remote procedure calls. The server processes may execute the functionality being requested by the remote procedure calls, and, if applicable, provide a response that is to be returned to the threads being executed by the requesting host.

As is also illustrated in FIGS. 3 and 4, the apparatus 20 of FIG. 2a and the apparatus 10 of FIG. 1a act as intermediaries (as service scheduler and function dispatcher, respectively) between the threads issuing the remote procedure calls and the server processes hosted by the providing host. Accordingly, the forwarded remote procedure calls are obtained from the function dispatcher of the requesting host. Similarly, responses that are provided after executing the respective functionality may be provided to the function dispatcher of the requesting host.

On the side of the providing host, the apparatus 20, i.e., the processing circuitry, implements the service scheduler for scheduling the execution of the functionality in response to remote procedure calls. In this context, a service scheduler is an entity that schedules the remote procedure calls for execution by the respective server processes hosted by the providing host, i.e., that determines, which remote procedure call is to be executed when by which server process.

A major purpose of the information on the thread having issued the respective remote procedure call is support for concurrent execution of remote procedure calls that have been issued by different threads of a (e.g., the same) computer program. For example, the processing circuitry may execute the functionality associated with the forwarded remote procedure calls concurrently if the threads having issued the respective remote procedure calls are different. This may be achieved by using different thread queues (i.e., task queues) for the different queues. In this context, a thread queue defines a logical sequence of tasks (i.e., remote procedure calls) to be performed by a server process of the providing host. Tasks that are assigned to different thread queues may be executed concurrently. Thus, the processing circuitry may allow concurrent execution of threads of different thread queues.

The incoming forwarded remote procedure calls are assigned to the different thread queues. For example, the processing circuitry may assign each forwarded remote procedure call to one of a plurality of thread queues TQ1, TQ2, TQ3 (in FIG. 2a) based on the information on the thread having issued the respective remote procedure call (e.g., based on the concurrency identifier), and to execute the functionality associated with the forwarded remote procedure calls using a thread that is associated with the respective thread queue. Accordingly, as further shown in FIG. 2b, the method may comprise assigning 220 each forwarded remote procedure call to one of a plurality of thread queues TQ1, TQ2, TQ3 based on the information on the thread having issued the respective remote procedure call and executing 230 the functionality associated with the forwarded remote procedure calls using a thread that is associated with the respective thread queue. In other words, each incoming remote procedure call may be assigned to a thread queue, e.g., such that remote procedure calls from the same thread are assigned to the same thread queue and remote procedure calls from different threads are assigned to different thread queues.

There are different mechanisms for assigning the remote procedure calls to the different thread queues. For example, the processing circuitry may apply a hash function on the concurrency identifier included with the respective remote procedure call and assign the remote procedure call based on the result of the hash function. Alternatively, the processing circuitry may create a new thread queue every time it encounters a new concurrency identifier. Concurrency identifiers/thread queues that have not been used for a pre-defined time interval may be deleted, and be recreated another remote procedure call with a corresponding concurrency identifier or result of a hash function is encountered by the processing circuitry.

As outlined in connection with FIGS. 1a and 1b, apart from the concurrency identifier, additional information about the thread may be included with the remote procedure call. For example, information about a (thread/process) priority of the thread having issued the remote procedure call (e.g., a priority identifier) may be included with the remote procedure call. The processing circuitry may instruct the server processes to execute the remote procedure calls according to the priority of the thread having issued the remote procedure call.

In most cases, the remote procedure call yields a result, which is to be returned to the thread having issued the remote procedure call. Thus, the processing circuitry may provide responses to the requesting host after executing the respective functionality associated with the forwarded remote procedure calls. Accordingly, as further shown in FIG. 2b, the method may comprise providing 240 responses to the requesting host after executing the respective functionality associated with the forwarded remote procedure calls. For example, the responses may comprise the respective results of the remote procedure calls, and may be provided to the requesting host, and ultimately to the threads having issued the respective remote procedure calls.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the storage circuitry 26 or means for storing information 26 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 200 may be a server computer system, i.e., a computer system being used to serve functionality, such as functionality provided by the virtual machine, to one or more client computers.

The present computer system may further comprise memory. For example, the memory may be random access memory, such as dynamic random-access memory (DRAM), e.g., DRAM being part of a Dual Inline Memory Module (DIMM) or DRAM being part of High Bandwidth Memory. Alternatively, the memory may be persistent memory, e.g., persistent memory being part of a DIMM.

More details and aspects of the providing host 200, the apparatus 20, the device 20, the method, the computer program, and the requesting host 100 are mentioned in connection with the proposed concept or one or more examples described above or below (e.g., FIG. 1a to 1b, 3 to 4). The providing host 200, the apparatus 20, the device 20, the method, the computer program, and the requesting host 100 may comprise one or more additional optional features corresponding to one or more aspects of the proposed concept, or one or more examples described above or below.

Various examples of the present disclosure relate to a concept, e.g., a method, for preserving concurrency properties over synchronous or asynchronous connections in remote procedure calls.

The proposed concept may define a general approach to communicating concurrency information across a serial message link. It may describe a concept (e.g., a method) for passing concurrency information (e.g., the information on the thread having issued the remote procedure call illustrated in connection with FIGS. 1a to 2b) with the RPC message so that the server (e.g., the providing host) can attempt to reproduce the concurrency behavior as accurately as possible on the server. The proposed concept is independent of the marshaling and transport technology used and so can be implemented over a wide variety of existing and home-grown RPC implementations. The proposed concept may affect an execution of operations that are triggered by the sequence of functions an application, i.e., a computer program, invokes.

In the present concept, an application may be understood as software and/or hardware logic that originates function requests (e.g., remote procedure calls). A function dispatcher, which may be implemented by the apparatus, device, method, or computer program of FIGS. 1a and/or 1b, may be software and/or hardware logic that forwards function requests over an interconnect to a service scheduler (which may be implemented by the apparatus, device, method, or computer program of FIGS. 2a and/or 2b). (Remote Procedure) Calls may be sent asynchronously, and order might not be guaranteed. An interconnect may be any physical or logical mechanism for transmitting data suitable for describing a function call. For example, the interconnect may be a (computer) network or a PCIe (Peripheral Component Interconnect express) interconnect that supports RPCs, e.g., gRPC. A service scheduler may be logic responsible for forwarding function requests from the function dispatcher to a service. The service scheduler may not be in the order received. An executer may be software and/or hardware logic that performs the work described by the function.

FIG. 3 shows a schematic diagram of an example of the different actors. An application 300 uses an RPC implementation that comprises a function dispatcher 310 and a service scheduler 320 to schedule a series of function requests to be executed on a remote compute service called the executer (comprising the service scheduler 320). Function Requests are transmitted over an interconnect via the function dispatcher 310. The function dispatcher is an application side scheduler that emits function requests on behalf of the application, e.g., as quickly as possible.

The function dispatcher 310 has an API (e.g., an interface) to enable a Function Request to be sent remotely. The function dispatcher 310 provides client-side data (e.g., the information on the thread having issued the RPC) that is used to allow the service scheduler 320 to reproduce the concurrency properties. In the following, this client-provided data is called the ConcurrencyID (concurrency identifier). The ConcurrencyID may comprise, but not limited to, the client's calling thread ID (identifier), Process ID, node identifier and thread priority. The function dispatcher sends the request while blocking the calling application thread until the response is returned. Note that this assumes that blocking is the normal behavior for the call. Alternatively, non-blocking calls may be used, or both may be supported.

When the service scheduler 320 receives the function request it uses the ConcurrencyID to reproduce the concurrency behavior as best as possible, including thread priorities if desired. For example, the thread function calls may be mapped to task queues 331 to 333.

FIG. 4 shows an illustrative example of a flow of the algorithm. FIG. 4 shows the application 400 with threads t1-t3, the function dispatcher 410, the service scheduler 420, and task queues 431 to 433. In the example of FIG. 4, the service scheduler 420 uses a TCP/IP (Transmission Control Protocol/Internet Protocol) Session as the domain of a single multi-threaded application. (i.e., any messages coming from that session are from the application instance). For this example, the TCP session and a thread ID are sufficient to form the ConcurrencyID for the request.

The function dispatcher 410 on the application 400 side records the thread ID of the calling thread when constructing the function request message. The thread ID is combined with the session to form the ConcurrencyID on the client. The function dispatcher 410 transmits the messages as quickly as possible. Order between messages is not guaranteed. The service scheduler 420 receives the message and examines the ConcurrencyID. It uses the ConcurrencyID to hash to a per thread Thread Queue/Task Queue 431-433 where the function request is scheduled for execution. Functions scheduled on the same thread queue are executed serially. Functions scheduled on different queues are scheduled independently, thus allowing for concurrency.

Responses are returned to the application via the function dispatcher 410, which may unblock the waiting caller thread (not shown is diagram).

In the example of FIGS. 3 and 4, the application 300, 400 has three threads calling functions. The expected per-thread order of execution is: Thread T1: F1, F5, F7, thread T2: F4, F6 and thread T3: F2,F3,F8. The order of function execution between threads is undefined.

The service scheduler 420 has a thread pool on three thread queues 431, 432 and 433. A hash is used to map {thread ID, session ID} (i.e., the concurrencyID) to a queue number. (All) messages with the same thread ID from the same application instance will hash to the same queue. A single thread per queue services the requests, guaranteeing serialization and order. The number of {queue, ConcurrencyID} pairs is configurable. A number of {queue, ConcurrencyID} pairs greater than the maximum number of concurrent client threads may waste resources. A number of {queue, ConcurrencyID} pairs equal to the number of client threads provides the most accurate reproduction of the concurrency model but may be overkill in some cases. Smaller numbers may be preferred. This parameter may be tuned statically or at runtime.

More details and aspects of the concept for preserving concurrency properties over synchronous or asynchronous connections in remote procedure calls are mentioned in connection with the proposed concept or one or more examples described above or below (e.g., FIG. 1a to 1b). The concept for preserving concurrency properties over synchronous or asynchronous connections in remote procedure calls may comprise one or more additional optional features corresponding to one or more aspects of the proposed concept, or one or more examples described above or below.

In the following, some examples of the proposed concept are presented:

An example (e.g., example 1) relates to a non-transitory, computer-readable medium comprising machine-readable instructions that, when the program code is executed on a processor (14) of a requesting host (100), causes the processor (14) to provide an interface (102) for locally receiving remote procedure calls from a plurality of threads (T1, T2, T3) of a computer program (104). The non-transitory, computer-readable medium comprises machine-readable instructions to forward, upon receiving a remote procedure call from one of the threads of the computer program, the remote procedure call to a providing host (200) that provides the functionality associated with the remote procedure call, wherein the remote procedure call is forwarded together with information on the thread having issued the remote procedure call.

Another example (e.g., example 2) relates to a previously described example (e.g., example 1) or to any of the examples described herein, further comprising that the machine-readable instructions comprise instructions to generate an identifier for identifying the thread having issued the remote procedure call, and to forward the remote procedure call together with the identifier for identifying the thread.

Another example (e.g., example 3) relates to a previously described example (e.g., example 2) or to any of the examples described herein, further comprising that the machine-readable instructions comprise instructions to derive the identifier from an operating-system generated thread identifier of the thread.

Another example (e.g., example 4) relates to a previously described example (e.g., one of the examples 2 to 3) or to any of the examples described herein, further comprising that the machine-readable instructions comprise instructions to derive the identifier from an identifier of a communication session being established between an operating system being used to execute the computer program and the providing host.

Another example (e.g., example 5) relates to a previously described example (e.g., one of the examples 1 to 4) or to any of the examples described herein, further comprising that the machine-readable instructions comprise instructions to forward, upon receiving remote procedure calls from different threads, the remote procedure calls with information for distinguishing the threads having issued the remote procedure calls.

Another example (e.g., example 6) relates to a previously described example (e.g., example 5) or to any of the examples described herein, further comprising that the machine-readable instructions comprise instructions to generate, for each of the threads having issued a remote procedure call, an identifier for identifying the thread having issued the respective remote procedure call, and to forward the remote procedure call together with the respective identifiers for identifying the thread.

Another example (e.g., example 7) relates to a previously described example (e.g., one of the examples 1 to 6) or to any of the examples described herein, further comprising that the machine-readable instructions comprise instructions to forward, upon receiving a response from the providing host in response to a remote procedure call, the response to the respective thread having issued the remote procedure call having triggered the response.

Another example (e.g., example 8) relates to a previously described example (e.g., one of the examples 1 to 7) or to any of the examples described herein, further comprising that the forwarded remote procedure calls are forwarded to a service scheduler of the providing host, and/or wherein responses received from the providing host are received from the service scheduler of the providing host.

Another example (e.g., example 9) relates to a previously described example (e.g., one of the examples 1 to 8) or to any of the examples described herein, further comprising that the machine-readable instructions implement a function dispatcher for forwarding the remote procedure calls to the providing host.

An example (e.g., example 10) relates to a non-transitory, computer-readable medium comprising machine-readable instructions that, when the program code is executed on a processor (24) of a providing host (200), causes the processor (24) to obtain, from a requesting host (100) requesting access to functionality being provided by the providing host, forwarded remote procedure calls, wherein the remote procedure calls are forwarded together with information on a thread having issued the respective remote procedure call. The non-transitory, computer-readable medium comprises machine-readable instructions to execute functionality associated with the forwarded remote procedure calls based on the information on the thread having issued the respective remote procedure call.

Another example (e.g., example 11) relates to a previously described example (e.g., example 10) or to any of the examples described herein, further comprising that the machine-readable instructions comprise instructions to execute the functionality associated with the forwarded remote procedure calls concurrently if the threads having issued the respective remote procedure calls are different.

Another example (e.g., example 12) relates to a previously described example (e.g., one of the examples 10 to 11) or to any of the examples described herein, further comprising that the machine-readable instructions comprise instructions to assign each forwarded remote procedure call to one of a plurality of thread queues (TQ1, TQ2, TQ3) based on the information on the thread having issued the respective remote procedure call, and to execute the functionality associated with the forwarded remote procedure calls using a thread that is associated with the respective thread queue.

Another example (e.g., example 13) relates to a previously described example (e.g., one of the examples 10 to 12) or to any of the examples described herein, further comprising that the machine-readable instructions comprise instructions to allow concurrent execution of threads of different thread queues.

Another example (e.g., example 14) relates to a previously described example (e.g., one of the examples 10 to 13) or to any of the examples described herein, further comprising that the machine-readable instructions comprise instructions to provide responses to the requesting host after executing the respective functionality associated with the forwarded remote procedure calls.

Another example (e.g., example 15) relates to a previously described example (e.g., one of the examples 10 to 14) or to any of the examples described herein, further comprising that the forwarded remote procedure calls are obtained from a function dispatcher of the requesting host, and/or wherein responses provided after executing the respective functionality are provided to the function dispatcher of the requesting host.

Another example (e.g., example 16) relates to a previously described example (e.g., one of the examples 10 to 15) or to any of the examples described herein, further comprising that the machine-readable instructions implement a service scheduler for scheduling the execution of the functionality in response to remote procedure calls.

An example (e.g., example 17) relates to an apparatus (10) for a requesting host (100), the apparatus comprising interface circuitry (12), machine-readable instructions, and a processor (14) to execute the machine-readable instructions to provide an interface (102) for locally receiving remote procedure calls from a plurality of threads (T1, T2, T3) of a computer program (104). The machine-readable instructions comprise instructions to forward, upon receiving a remote procedure call from one of the threads of the computer program, the remote procedure call to a providing host (200) that provides the functionality associated with the remote procedure call, wherein the remote procedure call is forwarded together with information on the thread having issued the remote procedure call.

An example (e.g., example 18) relates to an apparatus (20) for a providing host (200), the apparatus comprising interface circuitry (22), machine-readable instructions, and a processor (24) to execute the machine-readable instructions to obtain, from a requesting host (100) requesting access to functionality being provided by the providing host, forwarded remote procedure calls, wherein the remote procedure calls are forwarded together with information on a thread having issued the respective remote procedure call. The machine-readable instructions comprise instructions to execute functionality associated with the forwarded remote procedure calls based on the information on the thread having issued the respective remote procedure call.

An example (e.g., example 19) relates to an apparatus (10) for a requesting host (100), the apparatus comprising a processor (14) configured to provide an interface (102) for locally receiving remote procedure calls from a plurality of threads (T1, T2, T3) of a computer program (104). The processor is to forward, upon receiving a remote procedure call from one of the threads of the computer program, the remote procedure call to a providing host (200) that provides the functionality associated with the remote procedure call, wherein the remote procedure call is forwarded together with information on the thread having issued the remote procedure call.

An example (e.g., example 20) relates to an apparatus (20) for a providing host (200), the apparatus comprising a processor configured to obtain, from a requesting host (100) requesting access to functionality being provided by the providing host, forwarded remote procedure calls, wherein the remote procedure calls are forwarded together with information on a thread having issued the respective remote procedure call. The processor is to execute functionality associated with the forwarded remote procedure calls based on the information on the thread having issued the respective remote procedure call.

An example (e.g., example 21) relates to a device (10) for a requesting host (100), the device comprising means for processing for providing an interface (102) for locally receiving remote procedure calls from a plurality of threads (T1, T2, T3) of a computer program (104). The means for processing is for forwarding, upon receiving a remote procedure call from one of the threads of the computer program, the remote procedure call to a providing host (200) that provides the functionality associated with the remote procedure call, wherein the remote procedure call is forwarded together with information on the thread having issued the remote procedure call.

An example (e.g., example 22) relates to a device (20) for a providing host (200), the device comprising means for processing for obtaining, from a requesting host (100) requesting access to functionality being provided by the providing host, forwarded remote procedure calls, wherein the remote procedure calls are forwarded together with information on a thread having issued the respective remote procedure call. The means for processing is for executing functionality associated with the forwarded remote procedure calls based on the information on the thread having issued the respective remote procedure call.

An example (e.g., example 23) relates to a method for a requesting host, the method comprising providing (110) an interface (102) for locally receiving remote procedure calls from a plurality of threads (T1, T2, T3) of a computer program (104). The method comprises forwarding (130), upon receiving (115) a remote procedure call from one of the threads of the computer program, the remote procedure call to a providing host (200) that provides the functionality associated with the remote procedure call, wherein the remote procedure call is forwarded together with information on the thread having issued the remote procedure call.

Another example (e.g., example 24) relates to a previously described example (e.g., example 23) or to any of the examples described herein, further comprising that the method comprises generating (120) an identifier for identifying the thread having issued the remote procedure call and forwarding (130) the remote procedure call together with the identifier for identifying the thread.

Another example (e.g., example 25) relates to a previously described example (e.g., example 24) or to any of the examples described herein, further comprising that the method comprises deriving (120) the identifier from an operating-system generated thread identifier of the thread.

Another example (e.g., example 26) relates to a previously described example (e.g., one of the examples 24 to 25) or to any of the examples described herein, further comprising that the method comprises deriving (120) the identifier from an identifier of a communication session being established between an operating system being used to execute the computer program and the providing host.

Another example (e.g., example 27) relates to a previously described example (e.g., one of the examples 23 to 26) or to any of the examples described herein, further comprising that the method comprises forwarding (130), upon receiving remote procedure calls from different threads, the remote procedure calls with information for distinguishing the threads having issued the remote procedure calls.

Another example (e.g., example 28) relates to a previously described example (e.g., example 27) or to any of the examples described herein, further comprising that the method comprises generating (120), for each of the threads having issued a remote procedure call, an identifier for identifying the thread having issued the respective remote procedure call, and forwarding (130) the remote procedure call together with the respective identifiers for identifying the thread.

Another example (e.g., example 29) relates to a previously described example (e.g., one of the examples 23 to 28) or to any of the examples described herein, further comprising that the method comprises forwarding (150), upon receiving (140) a response from the providing host in response to a remote procedure call, the response to the respective thread having issued the remote procedure call having triggered the response.

Another example (e.g., example 30) relates to a previously described example (e.g., one of the examples 23 to 29) or to any of the examples described herein, further comprising that the forwarded remote procedure calls are forwarded to a service scheduler (20) of the providing host, and/or wherein responses received from the providing host are received from the service scheduler (20) of the providing host.

Another example (e.g., example 31) relates to a previously described example (e.g., one of the examples 23 to 30) or to any of the examples described herein, further comprising that the method implements a function dispatcher for forwarding the remote procedure calls to the providing host.

An example (e.g., example 32) relates to a method for a providing host (200), the method comprising obtaining (210), from a requesting host (100) requesting access to functionality being provided by the providing host, forwarded remote procedure calls, wherein the remote procedure calls are forwarded together with information on a thread having issued the respective remote procedure call. The method comprises executing (230) functionality associated with the forwarded remote procedure calls based on the information on the thread having issued the respective remote procedure call.

Another example (e.g., example 33) relates to a previously described example (e.g., example 32) or to any of the examples described herein, further comprising that the method comprises executing (230) the functionality associated with the forwarded remote procedure calls concurrently if the threads having issued the respective remote procedure calls are different.

Another example (e.g., example 34) relates to a previously described example (e.g., one of the examples 32 to 33) or to any of the examples described herein, further comprising that the method comprises assigning (220) each forwarded remote procedure call to one of a plurality of thread queues (TQ1, TQ2, TQ3) based on the information on the thread having issued the respective remote procedure call and executing (230) the functionality associated with the forwarded remote procedure calls using a thread that is associated with the respective thread queue.

Another example (e.g., example 35) relates to a previously described example (e.g., one of the examples 32 to 34) or to any of the examples described herein, further comprising that the method allows concurrent execution of threads of different thread queues.

Another example (e.g., example 36) relates to a previously described example (e.g., one of the examples 32 to 35) or to any of the examples described herein, further comprising that the method comprises providing (240) responses to the requesting host after executing the respective functionality associated with the forwarded remote procedure calls.

Another example (e.g., example 37) relates to a previously described example (e.g., one of the examples 32 to 36) or to any of the examples described herein, further comprising that the forwarded remote procedure calls are obtained from a function dispatcher (10) of the requesting host, and/or wherein responses provided after executing the respective functionality are provided to the function dispatcher (10) of the requesting host.

Another example (e.g., example 38) relates to a previously described example (e.g., one of the examples 32 to 37) or to any of the examples described herein, further comprising that the method implements a service scheduler for scheduling the execution of the functionality in response to remote procedure calls.

An example (e.g., example 39) relates to a computer system (100) comprising one of the apparatus (10) of example 17 (or according to any other example), the apparatus (10) of example 19 (or according to any other example) and the device (10) of example 21 (or according to any other example).

An example (e.g., example 40) relates to a computer system (100) configured to perform the method of one of the examples 23 to 31 (or according to any other example).

An example (e.g., example 41) relates to a computer system (200) comprising one of the apparatus (20) of example 18 (or according to any other example), the apparatus (20) of example 20 (or according to any other example) and the device (20) of example 22 (or according to any other example).

An example (e.g., example 42) relates to a computer system (200) configured to perform the method of one of the examples 32 to 38 (or according to any other example).

An example (e.g., example 43) relates to a system comprising the computer system of one of the examples 39 or 40 (or according to any other example) as requesting host and the computer system of one of the examples 41 or 42 (or according to any other example) as providing host.

An example (e.g., example 44) relates to a non-transitory machine-readable storage medium including program code, when executed, to cause a machine to perform the method of one of the examples 23 to 31 (or according to any other example) or the method according to one of the examples 32 to 38 (or according to any other example).

An example (e.g., example 45) relates to a computer program having a program code for performing the method of one of the examples the method of one of the examples 23 to 31 (or according to any other example) or the method according to one of the examples 32 to 38 (or according to any other example) when the computer program is executed on a computer, a processor, or a programmable hardware component.

An example (e.g., example 46) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory, computer-readable medium comprising machine-readable instructions that, when the program code is executed on a processor of a requesting host, causes the processor to:
provide an interface for locally receiving remote procedure calls from a plurality of threads of a computer program; and
forward, upon receiving a remote procedure call from one of the threads of the computer program, the remote procedure call to a providing host that provides the functionality associated with the remote procedure call,
wherein the remote procedure call is forwarded together with information on the thread having issued the remote procedure call.

2. The non-transitory, computer-readable medium according to claim 1, wherein the machine-readable instructions comprise instructions to generate an identifier for identifying the thread having issued the remote procedure call, and to forward the remote procedure call together with the identifier for identifying the thread.

3. The non-transitory, computer-readable medium according to claim 2, wherein the machine-readable instructions comprise instructions to derive the identifier from an operating-system generated thread identifier of the thread.

4. The non-transitory, computer-readable medium according to claim 2, wherein the machine-readable instructions comprise instructions to derive the identifier from an identifier of a communication session being established between an operating system being used to execute the computer program and the providing host.

5. The non-transitory, computer-readable medium according to claim 1, wherein the machine-readable instructions comprise instructions to forward, upon receiving remote procedure calls from different threads, the remote procedure calls with information for distinguishing the threads having issued the remote procedure calls.

6. The non-transitory, computer-readable medium according to claim 5, wherein the machine-readable instructions comprise instructions to generate, for each of the threads having issued a remote procedure call, an identifier for identifying the thread having issued the respective remote procedure call, and to forward the remote procedure call together with the respective identifiers for identifying the thread.

7. The non-transitory, computer-readable medium according to claim 1, wherein the machine-readable instructions comprise instructions to forward, upon receiving a response from the providing host in response to a remote procedure call, the response to the respective thread having issued the remote procedure call having triggered the response.

8. The non-transitory, computer-readable medium according to claim 1, wherein the forwarded remote procedure calls are forwarded to a service scheduler of the providing host, and/or wherein responses received from the providing host are received from the service scheduler of the providing host.

9. The non-transitory, computer-readable medium according to claim 1, wherein the machine-readable instructions implement a function dispatcher for forwarding the remote procedure calls to the providing host.

10. A non-transitory, computer-readable medium comprising machine-readable instructions that, when the program code is executed on a processor of a providing host, causes the processor to:
obtain, from a requesting host requesting access to functionality being provided by the providing host, forwarded remote procedure calls, wherein the remote procedure calls are forwarded together with information on a thread having issued the respective remote procedure call; and
execute functionality associated with the forwarded remote procedure calls based on the information on the thread having issued the respective remote procedure call.

11. The non-transitory, computer-readable medium according to claim 10, wherein the machine-readable instructions comprise instructions to execute the functionality associated with the forwarded remote procedure calls concurrently if the threads having issued the respective remote procedure calls are different.

12. The non-transitory, computer-readable medium according to claim 10, wherein the machine-readable instructions comprise instructions to assign each forwarded remote procedure call to one of a plurality of thread queues based on the information on the thread having issued the respective remote procedure call, and to execute the functionality associated with the forwarded remote procedure calls using a thread that is associated with the respective thread queue.

13. The non-transitory, computer-readable medium according to claim 10, wherein the machine-readable instructions comprise instructions to allow concurrent execution of threads of different thread queues.

14. The non-transitory, computer-readable medium according to claim 10, wherein the machine-readable instructions comprise instructions to provide responses to the requesting host after executing the respective functionality associated with the forwarded remote procedure calls.

15. The non-transitory, computer-readable medium according to claim 10, wherein the forwarded remote procedure calls are obtained from a function dispatcher of the requesting host, and/or wherein responses provided after executing the respective functionality are provided to the function dispatcher of the requesting host.

16. The non-transitory, computer-readable medium according to claim 10, wherein the machine-readable instructions implement a service scheduler for scheduling the execution of the functionality in response to remote procedure calls.

17. An apparatus for a requesting host, the apparatus comprising interface circuitry, machine-readable instructions, and a processor to execute the machine-readable instructions to:
provide an interface for locally receiving remote procedure calls from a plurality of threads of a computer program; and
forward, upon receiving a remote procedure call from one of the threads of the computer program, the remote procedure call to a providing host that provides the functionality associated with the remote procedure call,
wherein the remote procedure call is forwarded together with information on the thread having issued the remote procedure call.

18. An apparatus for a providing host, the apparatus comprising interface circuitry, machine-readable instructions, and a processor to execute the machine-readable instructions to:
obtain, from a requesting host requesting access to functionality being provided by the providing host, forwarded remote procedure calls, wherein the remote procedure calls are forwarded together with information on a thread having issued the respective remote procedure call; and
execute functionality associated with the forwarded remote procedure calls based on the information on the thread having issued the respective remote procedure call.

19. A computer system comprising the apparatus of claim 17.

20. A computer system comprising the apparatus of claim 18.
